(19) United States
(12) Patent Application Publication
(10) Pub. No.: US 2026/0160851 A1
(43) Pub. Date: Jun. 11, 2026

(54) METHODS OF SMART ROAD LOCALIZATION USING RADIO TRANSMITTERS

(71) Applicant: Torc Robotics, Inc., Blacksburg, VA (US)

(72) Inventors: William Gray Davis, Austin, TX (US); Akshay Pai Raikar, Austin, TX (US); Joseph R. Fox-Rabinovitz, Austin, TX (US)

(21) Appl. No.: 18/974,190

(22) Filed: Dec. 9, 2024

(51) Int. Cl. G01S 5/02; G01S 5/08

(52) U.S. Cl. CPC G01S 5/02521; G01S 5/08

(57) ABSTRACT

A road localization system for determining the position of an autonomous vehicle (AV) along a route is disclosed. The system includes a memory for storing machine-executable instructions and a processor configured to receive signals from a plurality of radio transmitters positioned along a road. Each transmitter sends road information and a unique identifier (ID) to the AV. The received signals and IDs are processed using a particle filter, where position information derived from the signals is used to identify corresponding transmitter positions on a map. The AV's position is determined based on the processed signals, and the system provides the AV with directions and orders based on the identified location. The system routes the AV along the route by continuously processing localization information from the signals of the transmitters to ensure accurate navigation.

### FIELD OF THE TECHNOLOGY

The field of the disclosure pertains to using high and low-power radio transmitters placed at intervals along a roadway to triangulate a vehicle's position and provide local road information.

### BACKGROUND OF THE TECHNOLOGY

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Localization of vehicles traveling along roads is essential for autonomous navigation, route planning, and ensuring safe and efficient transport to a designated destination. Accurate localization enables an autonomous vehicle (AV) to determine a position relative to the road, surrounding infrastructure, and other vehicles. Vehicle localization systems allows the AV to continuously adapt to changing road conditions, optimize routing, and follow designated paths. Vehicle localization systems utilize various technologies, including GPS, radio transmitters, and sensor fusion, to provide real-time positioning data. These systems are important in supporting autonomous operations by allowing the AV to traverse roads with minimal human intervention while maintaining precise control and adherence to traffic rules.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE TECHNOLOGY

In one aspect, a road localization system for determining the position of an autonomous vehicle (AV) along a route comprises at least one memory configured to store machine-executable instructions. The system further includes at least one processor configured to execute the stored instructions, enabling the AV to receive signals from a plurality of radio transmitters positioned along the road. Each signal contains road information for the specific road being traversed by the AV, as well as a unique identifier (ID) associated with each transmitter in communication with the AV. The system processes these received signals and unique IDs through a particle filter, with the processing unit utilizing the position information derived from the signals to identify the corresponding locations of the transmitters on a map associated with each ID. Based on this processing, the system determines the AV's position on the road and generates localization information through the particle filter, providing the AV with directions and operational orders based on the identified position along the route. The AV is then routed along the road using the localization information processed from the signals of the plurality of transmitters.

In one aspect, an autonomous vehicle (AV) includes at least one memory configured to store machine-executable instructions. The AV further includes at least one processor configured to execute the stored instructions to receive signals from a plurality of radio transmitters positioned along a road. Each signal contains road information for the road being traversed by the AV, as well as a unique identifier (ID) associated with each transmitter in communication with the AV. The AV's processing unit is configured to process the received signals and unique IDs using a particle filter, where the processing unit utilizes position information derived from the signals to identify the corresponding positions of the transmitters on a map linked to each ID. Based on this processed data, the AV determines its position on the road, generating localization information from the particle filter to provide the AV with directions and one or more orders based on its identified position along the route. The AV is then navigated along the route using the localization information processed from the signals of the plurality of transmitters.

In one aspect, a method includes receiving signals from a plurality of radio transmitters positioned along a road, where each signal contains road information for a road being traversed by an autonomous vehicle (AV) and a unique identifier (ID) for each transmitter in communication with the AV. The method further includes processing, via a processing unit at the AV, the received signals and unique IDs from the transmitters using a particle filter, where the processing unit utilizes position information derived from the signals to identify the corresponding positions of the transmitters on a map associated with each ID. Based on the processed signals, the method determines the position of the AV on the road, with localization information being generated by the particle filter to provide the AV with directions and one or more orders according to the identified position along the route. The method further involves routing the AV along the route using the localization information processed from the signals of the plurality of transmitters.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck according to some aspects of the present disclosure;

FIG. 2 is a block diagram of the autonomous truck shown in FIG. 1, according to some aspects of the present disclosure;

FIG. 3 is an illustration of a highway localization system according to some aspects of the present.

FIG. 4 is a flow diagram of an example embodiment of a method of road localization for determining a position of disclosure an autonomous vehicle (AV) along a route according to some aspects of the present;

FIG. 5 is a block diagram of an example computing system according to some aspects of the present disclosure;

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level 4 or level 5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level 1, level 2, or level 3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level 0 recognized by NHTSA.

Localization: Localization is the process of precisely determining a vehicle's position within its environment, specifically along a mapped route or road. For AVs, accurate localization is utilized for safe navigation and route compliance. This process leverages data from sensors such as GPS, radio transmitters, LIDAR, or cameras to estimate the vehicle's location relative to road infrastructure, landmarks, or other reference points. Continuous updates to the vehicle's position enable real-time decision-making for steering, speed adjustments, and obstacle avoidance, ensuring adherence to traffic regulations and the designated path.

Triangulation: Triangulation is the process of processing signals transmitted from multiple stationary transmitters, enabling a vehicle to determine its position by passively receiving these signals. Using this data, the vehicle's processing unit applies triangulation algorithms to determine its precise location by analyzing the intersections of the signals from the transmitters, creating a real-time spatial fix that guides navigation along the designated route. This method ensures accurate localization without requiring the vehicle to send any signals back to the transmitters.

Autonomous vehicles (AVs) face persistent challenges in achieving reliable localization when navigating diverse routes and road conditions. Variations in road infrastructure, environmental factors, and GPS signal reliability often lead to inaccurate positioning, which can jeopardize vehicle safety and efficiency. Traditional methods, such as relying solely on GPS or vision-based systems, struggle to maintain precision in urban environments, tunnels, or areas with signal interference, leading to potential route deviations and navigation errors. These localization difficulties hinder the full autonomy of vehicles, creating a need for improved systems that ensure accurate, continuous position tracking across all road types and conditions.

Conventional localization technologies for autonomous vehicles primarily rely on Global Navigation Satellite Systems (GNSS) or Inertial Navigation Systems (INS) sensors. GNSS, while widely used, suffers from signal degradation in urban canyons, tunnels, or dense foliage, leading to inconsistent positioning accuracy. INS sensors, on the other hand, provide dead reckoning data based on the vehicle's motion, but their accuracy degrades over time due to sensor drift without external corrections. Despite their widespread use, both systems face challenges in maintaining consistent localization in challenging environments, creating the need for more robust and reliable solutions to ensure precise vehicle positioning across varying terrains and conditions.

The disclosed systems and methods encompass a localization system that utilizes a network of high-power and low-power transmitters equipped with unique beacons or antennas strategically positioned along the roadway. Each transmitter is configured to emit a signal that can be received by an autonomous vehicle (AV) to assist with the facilitation of precise localization on a digital map. The short-range nature of these transmitters enhances the localization process, as receiving a signal from a specific transmitter indicates proximity to that transmitter. By analyzing the angle of the received signal relative to the transmitter, the system can accurately ascertain the vehicle's position concerning that transmitter. Furthermore, as the AV receives signals from multiple transmitters, the AV can triangulate its location with greater accuracy, thus significantly improving the overall precision of the localization system. This innovative approach addresses the inherent challenges of existing technologies, providing a reliable solution for determining the AV's position along diverse routes.

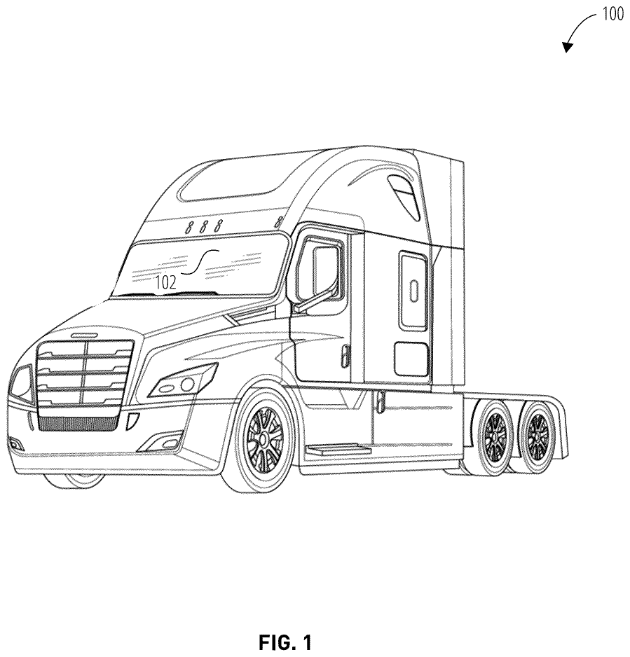

Various embodiments in the present disclosure are described with reference to FIGS. 1-4 below. Further, even though the embodiments are described for perception technologies used in autonomous vehicles, the embodiments described herein do not limit their scope to autonomous vehicles singularly and may be embodied in non-autonomous vehicles or semi-autonomous vehicles as well.

FIG. 1 illustrates an autonomous vehicle 100, such as a truck that may be conventionally connected to a single or tandem trailer to transport the trailer (not shown) to a desired location. The autonomous vehicle 100 includes a cabin 102 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 102.

The autonomous vehicle 100 may be an autonomous vehicle, in which case the autonomous vehicle 100 may omit the steering wheel and the steering column to steer the autonomous vehicle 100. Rather, the autonomous vehicle 100 may be operated by an autonomy computing system (not shown) of the autonomous vehicle 100 based on data collected by a sensor network (not shown in FIG. 1) including one or more sensors.

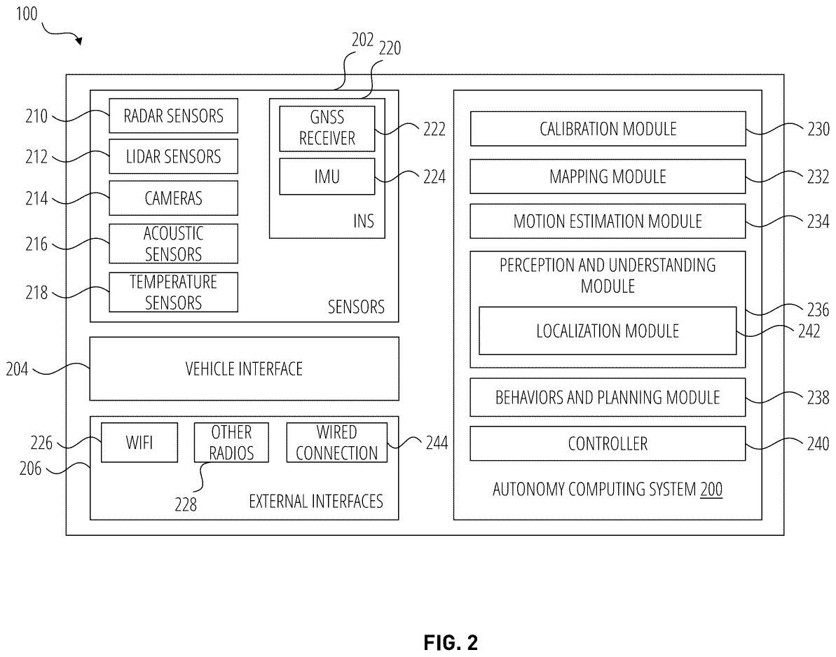

FIG. 2 is a block diagram of autonomous vehicle 100 shown in FIG. 1. In the example embodiment, autonomous vehicle 100 includes autonomy computing system 200, sensors 202, vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be utilized by autonomy computing system 200 for the localization of autonomous vehicle 100 concerning a plurality of low-power and high-power transmitters positioned along the road traversed by the autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In some embodiments, sensors 202, such as an inertial navigation system (INS) 220, GNSS receiver 222, and IMU 224 play a role in enhancing the localization capabilities of the autonomous vehicle 100. The autonomy computing system 200 utilizes data obtained from both the GNSS receiver 222 and IMU 224 to establish a communication link with a plurality of sensors or transmitters positioned along the road. By integrating this information, the autonomy computing system 200 can triangulate the vehicle's location more accurately, compensating for potential challenges of GNSS signals, such as multipath interference or signal blockage in urban environments.

Localization of autonomous vehicle 100 can be achieved with precision by strategically placing a combination of low-power and high-power radio transmitters throughout the environment and along various road types, including highways and local roads. These transmitters emit signals that the autonomous vehicle 100 can receive and use for triangulation, without requiring active communication from the vehicle itself. By analyzing the gradient of signal strength over time and the phase of the signals, the autonomous vehicle 100 can effectively determine its location and velocity by ranging against multiple transmitters. Furthermore, these transmitters can transmit local road information and localization signals, enhancing the situational awareness of the autonomous vehicle 100. This capability enables the road infrastructure to provide real-time directions and commands to vehicles in communication with the low-power and high-power radio transmitters, facilitating the offloading of mission-critical tasks and strategic plans to a centralized server.

In the example embodiment, autonomy computing system 200 employs vehicle interface 204 to send commands or data to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and the localization module 242.

The localization module 242, for example, may be embodied within another module, such as behaviors and planning module 238, or separately. Alternatively, the localization module 242 may be embodied within the perception and understanding module 236. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The localization module 242 is configured to enhance the accuracy of localization and the determination of a vehicle's known position while traversing a route. By improving the vehicle's positional awareness, the localization module 242 enables more effective navigation and decision-making processes.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

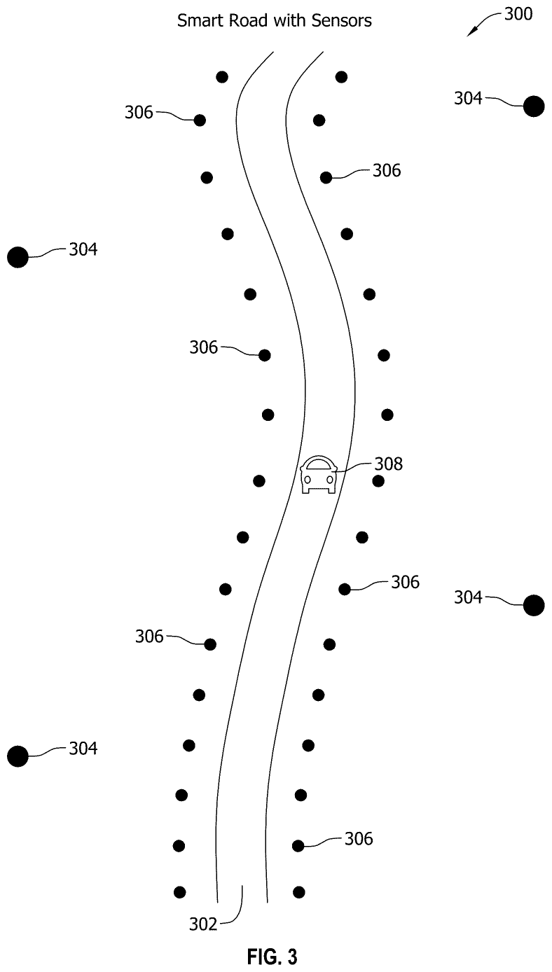

FIG. 3 is a highway localization system 300 according to some aspects of the present disclosure.

FIG. 3 illustrates a vehicle 308 traversing a road 302 along a designated route, where a combination of low-power radio transmitters 306 and high-power radio transmitters 304 are strategically positioned along the road 302 to enable precise localization of the vehicle. Low-power radio transmitters 306 are frequently spaced along the road and near its edges, ensuring that at least three transmitters are within range of any vehicle on the road 302. In some examples, these low-power transmitters can comprise Bluetooth or Wi-Fi signals, enabling short-range communication with the vehicle 308. For example, this localized communication allows a vehicle 308 to accurately determine its position and velocity by using the gradient of signal strength and phase shifts over time, effectively ranging against multiple transmitters. Additionally, the low-power radio transmitters 306 can transmit local road information, providing data that the vehicle 308 can use to receive directions and orders, further offloading mission and strategic planning tasks to a remote server.

High-power radio transmitters 304 are more widely spaced along the road 302 and are positioned further from the path of vehicle 308, often installed on existing infrastructure such as lamp posts, radio towers, or buildings. These high-power radio transmitters 304 are primarily used for precision pose estimation, transmitting a simple signal (e.g., a “chirp”) to enhance the ability of vehicle 308 to triangulate its position over longer distances. Thus, high-power radio transmitters 304 long-range capability complements the shorter-range low-power transmitters to provide comprehensive localization of the vehicle 308.

In some examples, both the high-power radio transmitters 304 and low-power radio transmitters 306 transmit data that includes a unique transmitter identification (ID). Vehicle 308 processes the received signals through a particle filter, associating each transmitter ID with a corresponding position on the map. A particle filter is an algorithm that tracks multiple hypotheses (particles) about the position of vehicle 308, updating and refining these hypotheses as new signal data is received. Vehicle 308 can continuously refine its localization estimates by correlating the transmitter IDs with known map positions. This results in highly accurate localization, with positioning precision achievable within a few centimeters, ensuring reliable and precise navigation along the route.

As the vehicle continues along road 302, the vehicle remains in constant communication with at least three transmitters—whether low-power or high-power—allowing the vehicle 308 to localize more effectively and navigate the route with confidence. Combining short-range signals from Bluetooth or Wi-Fi transmitters and long-range signals from high-power transmitters creates a robust localization system that enables vehicle 308 to respond accurately to the environment surrounding vehicle 308 while traversing various road conditions.

In some examples, the vehicle, while traveling along road 302, would receive signals from both high-power radio transmitters 304 and low-power radio transmitters 306, which are long-range transmitters and short-range transmitters, respectively. The high-power radio transmitters 304 would identify the zone in which the vehicle is currently located, providing broad localization data. Based on the identified zone, the low-power radio transmitters 306, positioned more densely along the road, would then provide specific, fine-grained localization information. Although, in some examples, the low-power radio transmitters 306 IDs may repeat across different zones, while the high-power radio transmitters 304 serves as a unique identifier for each zone, allowing vehicle 308 to differentiate between identical short-range transmitter IDs in different areas.

In some examples, localization can be performed by the vehicle using the signals from one or more of the high-power radio transmitters 304 and low-power radio transmitters 306, by calculating the angle between the vehicle and the transmitters. A processing unit at the vehicle can determine the angle from the truck to each individual high-power radio transmitters 304 and low-power radio transmitters 306, allowing for precise positioning without the need for additional data. Alternatively, signals received from the high-power radio transmitters 304 and low-power radio transmitters 306 can be fed into a particle filter at vehicle 308. By determining the relative angles of multiple beacons to the vehicle, the particle filter can calculate both the position of the vehicle and the orientation of the vehicle.

In some examples, the vehicle can perform both phase and angle determinations by transmitting a signal to one or more of the high-power radio transmitters 304 and low-power radio transmitters 306. Upon receiving a response signal, vehicle 308 calculates the power level of the returned signal. Since the transmitters emit the signal at maximum power, vehicle 308 can assess the distance traveled by comparing the strength of the received signal to the original transmission power or to a predetermined threshold. The greater the reduction in signal strength, the farther the signal has traveled. By analyzing this power difference, vehicle 308 can identify the distances from the transmitter at a current position. Furthermore, vehicle 308 can determine whether vehicle 308 is moving closer to or farther away from the transmitter based on one or more changes in the signal strength.

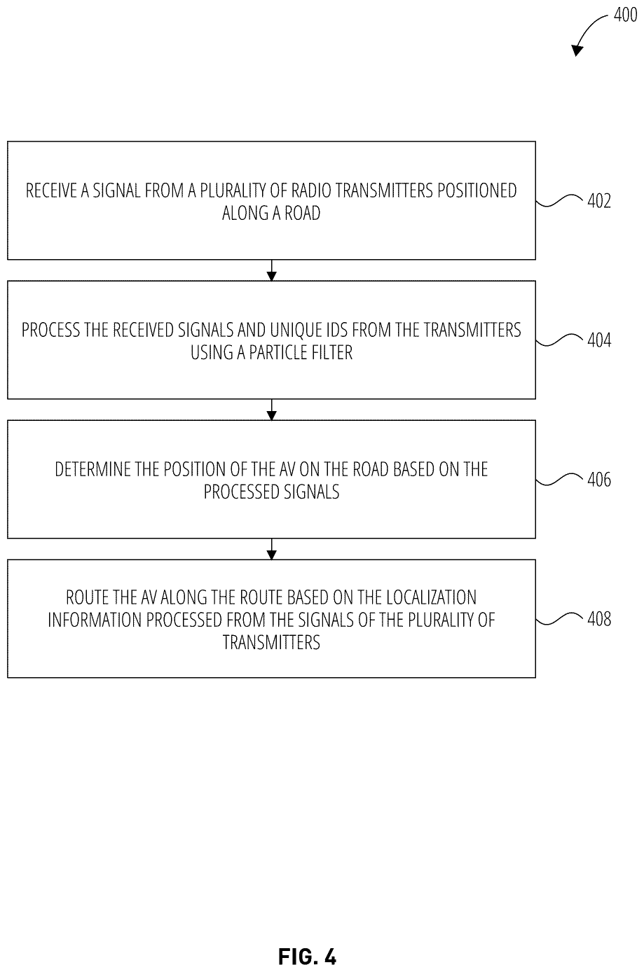

FIG. 4 is a flow diagram of an example embodiment of a method 400 of road localization for determining a position of an autonomous vehicle (AV) along a route according to some aspects of the present disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 includes receiving 402 a signal from a plurality of radio transmitters positioned along a road. For example, the localization module 242, as shown in FIG. 2, may receive 40 signals from a plurality of radio transmitters positioned along a roadway. These signals contain road information for the path being traveled by an autonomous vehicle AV, along with an ID for each transmitter in communication with the AV. The plurality of radio transmitters includes at least three transmitters, each positioned at distinct locations along the road and spaced apart from one another.

According to some examples, the method 400 includes processing 404 the received signals and unique IDs from the transmitters using a particle filter. For example, the localization module 242, as depicted in FIG. 2, may process 404 the received signals and unique IDs from the transmitters utilizing a particle filter. The controller leverages position information derived from these signals to identify corresponding transmitter positions on a map linked to each unique ID. Upon transmission of a signal from the AV, a response signal is received from the plurality of radio transmitters in communication with the AV. The power level of each received signal is measured, and the AV assesses whether the power level exceeds a predefined threshold. If the threshold is not exceeded, the AV determines the distance to each transmitter based on the reduction in signal strength. The velocity of the AV is determined by first calculating the AV's position at an initial time step, based on localization data processed from a signal received from the plurality of transmitters. A second position is calculated at a subsequent time step based on updated localization information from another signal received from the transmitters. The velocity is then calculated by measuring the distance traveled between the first and second positions and dividing that distance by the time interval between the two time steps.

According to some examples, the method 400 includes determining 406 the position of the AV on the road based on the processed signals. For example, the localization module 242, as illustrated in FIG. 2, may determine 406 the position of the AV on the road based on the processed signals received from the transmitters. Localization data is derived from the particle filter, enabling the AV to receive directions and one or more commands based on its identified position along the route. The autonomy computing system 200 identifies the angle of each transmitter relative to the AV using the signals received from the transmitters. The autonomy computing system 200 then determines the orientation of the AV based on the position of one or more transmitters relative to the AV. By combining orientation and position data processed by the particle filter, the current location of the AV is refined to further improve the accuracy of the vehicle's position along the road.

According to some examples, the method 400 includes routing 408 the AV along the route based on the localization information processed from the signals of the plurality of transmitters. For example, the localization module 242, as illustrated in FIG. 2, may guide the AV along its route using localization data processed from the signals received from the plurality of transmitters.

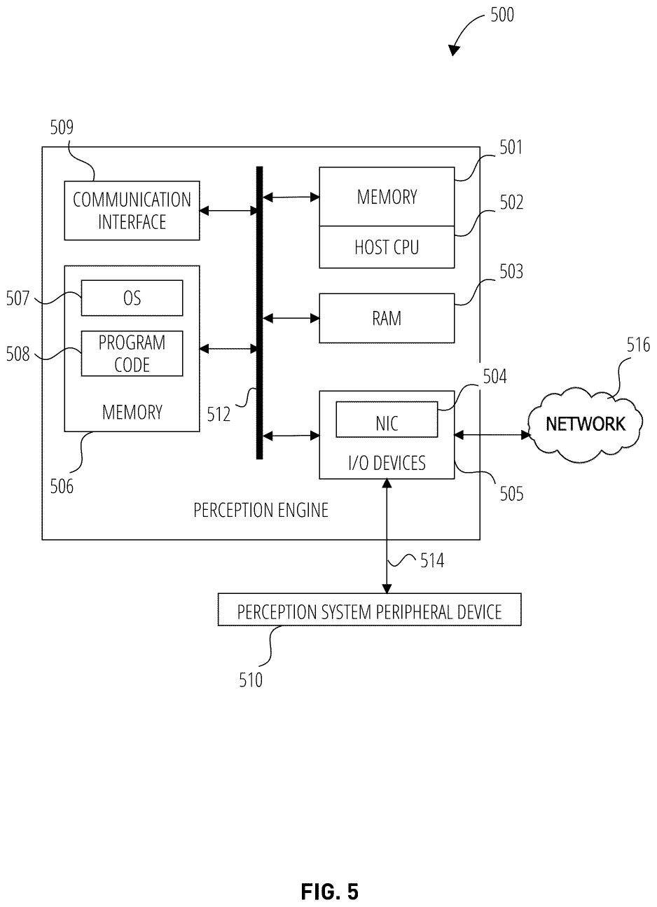

FIG. 5 is a block diagram of an example computing system 500, such as the autonomy computing system 200 shown in FIG. 2, configured for sensing an environment in which an autonomous vehicle is positioned. Computing system 500 includes a Host CPU 501 coupled to a CACHE memory 506, and further coupled to RAM 503 and memory 506 via a memory bus 512. CACHE memory 506 and RAM 503 are configured to operate in combination with Host CPU 501. Memory 506 is a computer-readable memory (e.g., volatile, or non-volatile) that includes at least a memory section storing an OS 507 and a section storing program code 508. Program code 508 may be one of the modules in the autonomy computing system 200 shown in FIG. 2. In alternative embodiments, one or more section of memory 506 may be omitted and the data stored remotely. For example, in certain embodiments, program code 508 may be stored remotely on a server or mass-storage device and made available over a network 516 to Host CPU 501.

Computing system 500 also includes I/O Devices 505, which may include, for example, a Communication Interface such as a network interface controller (NIC) 504, or a peripheral interface for communicating with a perception system peripheral device Perception system peripheral device 510 over a peripheral link 514. I/O Devices 505 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) precise localization being achieved by placing radio transmitters in locations around the environment; (b) providing a signal from transmitters which the vehicles receive and can triangulate off of without actively receiving any signals from the vehicles; and (c) sending out data from transmitters that includes local road information as well as a localization signal, that includes directions and orders to the vehicles.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, challenges associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A road localization system for determining a position of an autonomous vehicle (AV) along a route, comprising:
at least one memory configured to store machine executable instructions; and
at least one processor coupled to the at least one memory and configured to execute the stored executable instructions to:
receive a signal from a plurality of radio transmitters positioned along a road, wherein the signal comprises road information for a road being traversed by the AV and a unique identifier (ID) for each transmitter in communication with the AV;
process the received signals and unique IDs from the transmitters using a particle filter, wherein the processing includes utilizing position information derived from the signals to identify corresponding positions of transmitters on a map associated with each ID;
determine the position of the AV on the road based on the processed signals, wherein localization information is determined from the particle filter to provide the AV with directions and one or more orders based on the identified position along a route; and
route the AV along the route based on the localization information processed from the signals of the plurality of transmitters.

2. The system of claim 1, wherein the plurality of radio transmitters includes at least three radio transmitters positioned at multiple locations along the road, spaced apart from one another.

3. The system of claim 1, further configured to:
identify an angle of each transmitter relative to the AV based on the signals received from the transmitters;
determine an orientation of the AV based on the position of one or more of the transmitters relative to the AV; and
determine a current location of the AV by combining orientation and position data processed by the particle filter to further refine the AV's location on the road.

4. The system of claim 1, further comprising:
in response to transmission of a signal from the AV, receiving a signal from the plurality of radio transmitters in communication with the AV;
measuring a power level of each received signal of the plurality of radio transmitters, wherein the AV determines whether a threshold power level is exceeded; and
in response to the threshold power level not being exceeding, determining a distance between the AV and each transmitter based on a reduction in signal strength.

5. The system of claim 1, wherein a velocity of the AV is determined from the signal received from the plurality of radio transmitters, the velocity determined by:
determining a first position of the AV at a first time step based on localization information processed from a first signal received from the plurality of transmitters;
determining a second position of the AV at a second time step based on updated localization information received from a second signal received from the plurality of transmitters; and
calculating a distance traveled between the first and second positions, the calculating including dividing the distance traveled by a time interval between the first and second time steps.

6. The system of claim 1, wherein the plurality of transmitters comprises one or more frequently spaced low power transmitters and one or more widely spaced high power transmitters.

7. The system of claim 6, wherein:
the one or more widely spaced high power transmitters are configured to identify a zone in which the AV is located, and
the one or more frequently spaced low power transmitters are configured to identify a specific location of the AV within the identified zone, wherein the identifiers (IDs) of the low power transmitters are repeated across different zones, and the high power transmitters provide zone differentiation for localization of the AV.

8. An autonomous vehicle (AV), comprising:
at least one sensor configured to receive signals from a plurality of radio transmitters positioned along a road, wherein the signal comprises road information for the road being traversed by the AV and a unique identifier (ID) for each transmitter in communication with the AV via at least one communication channel;
process the received signals and unique IDs using a particle filter, wherein the position information derived from the signals is used to identify corresponding positions of the transmitters on a map associated with each ID;
determine the position of the AV on the road based on the processed signals, wherein localization information is determined from the particle filter to provide the AV with directions and one or more orders based on the identified position along a route; and
route the AV along the route based on the localization information processed from the signals of the plurality of transmitters.

9. The vehicle of claim 8, wherein the plurality of radio transmitters includes at least three radio transmitters positioned at multiple locations along the road, spaced apart from one another.

10. The vehicle of claim 8, wherein the at least one sensor is further configured to:
identify an angle of each transmitter relative to the AV based on the signals received from the transmitters;
determine an orientation of the AV based on the position of one or more of the transmitters relative to the AV; and
determine a current location of the AV by combining orientation and position data processed by the particle filter to further refine the AV's location on the road.

11. The vehicle of claim 8, wherein the at least one sensor is further configured to:
in response to transmission of a signal from the AV, receiving a signal from the plurality of radio transmitters in communication with the AV;
measuring a power level of each received signal of the plurality of radio transmitters, wherein the AV determines whether a threshold power level is exceeded; and
in response to the threshold power level not being exceeding, determining a distance between the AV and each transmitter based on a reduction in signal strength.

12. The vehicle of claim 8, wherein a velocity of the AV is determined from the signal received from the plurality of radio transmitters, the velocity determined by:
determining a first position of the AV at a first time step based on localization information processed from a first signal received from the plurality of transmitters;
determining a second position of the AV at a second time step based on updated localization information received from a second signal received from the plurality of transmitters; and
calculating a distance traveled between the first and second positions, the calculating including dividing the distance traveled by a time interval between the first and second time steps.

13. The vehicle of claim 8, wherein the plurality of transmitters comprises one or more frequently spaced low power transmitters and one or more widely spaced high power transmitters.

14. The vehicle of claim 13, wherein:
the one or more widely spaced high power transmitters are configured to identify a zone in which the AV is located, and
the one or more frequently spaced low power transmitters are configured to identify a specific location of the AV within the identified zone, wherein the identifiers (IDs) of the low power transmitters are repeated across different zones, and the high power transmitters provide zone differentiation for localization of the AV.

15. A method, comprising:
receiving a signal from a plurality of radio transmitters positioned along a road, wherein the signal comprises road information for a road being traversed by an autonomous vehicle (AV) and a unique identifier (ID) for each transmitter in communication with the AV;
processing, via a processing unit at the AV, the received signals and unique IDs from the transmitters using a particle filter, wherein the processing unit utilizes position information derived from the signals to identify corresponding positions of transmitters on a map associated with each ID;
determining the position of the AV on the road based on the processed signals, wherein localization information is determined from the particle filter to provide the AV with directions and one or more orders based on the identified position along a route; and
routing the AV along the route based on the localization information processed from the signals of the plurality of transmitters.

16. The method of claim 15, wherein the plurality of radio transmitters includes at least three radio transmitters positioned at multiple locations along the road, spaced apart from one another.

17. The method of claim 15, further comprising:
identifying an angle of each transmitter relative to the AV based on the signals received from the transmitters;
determining an orientation of the AV based on the position of one or more of the transmitters relative to the AV; and
determining a current location of the AV by combining orientation and position data processed by the particle filter to further refine the AV's location on the road.

18. The method of claim 15, further comprising:
in response to transmission of a signal from the AV, receiving a signal from the plurality of radio transmitters in communication with the AV;
measuring a power level of each received signal of the plurality of radio transmitters, wherein the AV determines whether a threshold power level is exceeded; and
in response to the threshold power level not being exceeding, determining a distance between the AV and each transmitter based on a reduction in signal strength.

19. The method of claim 15, wherein a velocity of the AV is determined from the signal received from the plurality of radio transmitters, the velocity determined by:
determining a first position of the AV at a first time step based on localization information processed from a first signal received from the plurality of transmitters;
determining a second position of the AV at a second time step based on updated localization information received from a second signal received from the plurality of transmitters; and
calculating a distance traveled between the first and second positions, the calculating including dividing the distance traveled by a time interval between the first and second time steps.

20. The method of claim 15, wherein:
one or more widely spaced high power transmitters are configured to identify a zone in which the AV is located, and
one or more frequently spaced low power transmitters are configured to identify a specific location of the AV within the identified zone, wherein the identifiers (IDs) of the low power transmitters are repeated across different zones, and the high power transmitters provide zone differentiation for localization of the AV.
